(19) United States
(12) Patent Application Publication
(10) Pub. No.: US 2009/0044236 A1
(43) Pub. Date: Feb. 12, 2009

(54) Method for Providing a Multimedia Service on Demand, Service Platform, Program and Decoder for Implementing the Method

(75) Inventors: Halim Bendiabdallah, Marne La Coquette (FR); Jean-Paul Rodrigues, Clamart (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/224,741

(22) PCT Filed: Feb. 23, 2007
(86) PCT No.: PCT/FR2007/050846

§ 371 Date: Sep. 2, 2008

(30) Foreign Application Priority Data
Mar. 1, 2006 (FR) 0601826

(51) Int. Cl. H04N 7/173

(52) U.S. Cl. 725/87

(57) ABSTRACT

The on-demand multimedia service is provided on the basis of multimedia data sources (3) each comprising at least one program stream. The program stream of a source is converted into a transport stream transmitted to a user terminal along a first channel by way of a telecommunication network. Packets describing elements overlayable on a video component of the transport stream are furthermore extracted from the program stream. In response to a request originating from the user terminal, the service platform converts at least one of the packets describing overlayable elements into a data page returned to the user terminal along a second channel different from the first channel by way of the telecommunication network. On receipt of the data page at the user terminal, the overlayable elements are recovered and displayed in overlay with the video component of the transport stream.

The present invention relates to the provision of on-demand multimedia services by way of telecommunication networks. A particular field of application thereof is that of digital television in which a widespread standard is MPEG2.

The MPEG2 system standard defines two types of multiplexed digital streams: transport streams (TS) and program streams (PS). A “program” is defined as a set of temporally correlated elementary streams, that is to say each carrying information to be restored with respect to a common time base. A PS stream carries a single program in the form of packets of relatively significant and optionally variable length. The program streams (PS) are generally used for storing programs on disk. The transport streams (TS) are composed of packets of fixed length belonging to one or more programs and are used for transmitting or broadcasting on networks.

These TS, PS multiplexed streams are constructed on the basis of packetized elementary streams (PES). The raw elementary streams (ES) arising directly from the video or audio coding are firstly put into the form of PES packets of variable length. The PES streams are thereafter segmented to constitute the TS or PS packets to be multiplexed.

The MPEG2 standard is used in several systems for distributing multimedia contents, in particular DVD (“Digital Versatile Disc”) and DVB (“Digital Video Broadcast”).

The DVD is an optical recording medium disk on which the programs are recorded in so-called VOB (“Video Object Block”) files which correspond to PS stream packets. So-called IFO files are also recorded on the disk and contain the information on the chapters, the sub-title tracks and the sound tracks. The IFO files make it possible to offer the user navigation and interactivity elements, in particular for choosing the languages or sub-titles, sometimes for choosing the camera angles, for accessing the main menu and the intermediate menus, to advance or retreat through the chapters of the program, etc. The DVD also contains so-called BUP files, which are backups of the IFO files.

In a DVD, the multimedia content (VOB), including the sound, the images and the sub-titles, is therefore dissociated from the tree (IFO) between the various menus. The interactivity of the DVD relies on displaying the video sequence. The IFO files make it possible to select the video portions to be restored as a function of the actions triggered by the user, in general with the aid of his remote control. The succession of the various video portions creates the interactivity by way of a navigation tree. The DVD reader possesses five 16-bit registers for storing optional information making it possible to act on the tree followed in the IFO file as a function of the earlier choices.

The video sequences of a DVD are encoded in accordance with the MPEG2 standard. MPEG2 compression consists in slicing the video sequence into image blocks called GOPs (“Groups of Pictures”) with an approximate duration of twelve images. It supplements this with the audio component or components, the optional sub-titles and the other data, inter alia for navigation. These various things form what is called a VOBU (“Video Object Unit”), which is therefore a subset of the video sequence. A chapter is a “program” consisting of “cells”, themselves consisting of VOBUs. A film composed of several chapters is a succession of “programs” also called a PGC (“Program Chain”). A DVD can be seen as a succession of PGCs with a control structure, coded in the IFO files, making it possible to chain them together or to navigate among these PGCs.

The interactivity offered by a DVD comprises the ability to navigate among video sequences. At each cell end, a command is inserted enabling the decoder to determine the next action to be executed. The interactivity is contained in PESs specific to the DVD standard. In particular, the definition of the buttons presented on the screen is in a special packet called PCI (“Presentation Control Information”). This packet PCI is always (whether or not there are buttons to be displayed) in the first sector of each VOBU, that is to say in its first 2048 bytes. Therein is a table that can contain the definition of a maximum number of 36 buttons. This definition corresponds to the following data structure:
the coordinates x, y of the button;
a number of a table out of three possible tables providing the color and the contrast according to the state of the button (activated or otherwise);
an indicator “Action auto” which makes it possible to activate the button as soon as it is selected (it is then unnecessary to press the ENTER key of the remote control);
the number of the following buttons for navigation;
finally a command executed on activation of the button, in relation with the IFO file.

On reading the DVD, a PS stream demultiplexer separates the audio PESs, the video PESs and the PESs containing the descriptions of sub-titles, as well as the packets PCI for the descriptions of interactivity buttons. An overlay function makes it possible to display several video planes in overlay, in particular the video and the sub-titles, the background of a menu page and the buttons, etc.

On a DVD, the sub-titles are recorded in the form of images which are displayed in overlay on the video stream by the reader. The sub-titles are situated in PS packets with no header 0×000001BA which contain PES packets with header 0×000001BD. There are up to thirty-two possible sub-titles tagged by the respective identifiers (SID, “subtitle identifier”).

A PES of sub-titles is composed of the size of the packet followed by the data and finally control data consisting of a list of control sequences. These control sequences called “subpicture display control sequences” or SP_DCSQ are chained tables of commands containing:
a waiting lag before the next sequence;
a pointer to the next SP_DCSQ; if this pointer designates the current SP_DCSP, it is the last of the sequence of sub-titles;
a series of commands from among nine possible commands.

The “sub-image” representing the sub-title is coded on two bits per pixel (0=background, 1=motif, 2=1^{st} level of emphasis, 3=2^{nd} level of emphasis 2). The stream contains a table which associates, with each of these four values, a color number in the palette of the PGC and a contrast level.

DVB is a standard for digital television broadcasting. The streams are broadcast in the TS format, which makes it possible to dispatch several programs in a given bandwidth. The user thus receives a “package” of channels and tables describing information such as names of the channels, names of the programs in progress, etc. These tables allow the user to locally select the channels to be displayed.

A TS stream has a simple and generic structure. A table is composed of sub-tables, themselves composed of sections. Each section is composed of a header and then of a list of descriptors or “tags” (unitary information elements). The TS stream transports MPEG2-compatible audio and video PES packets and also tables termed PSIs (“Program Specific Information”) containing the signaling. These tables PSI comprise a PAT (“Program Association Table”) describing each service physically present on the TS, a PMT (“Program Map Table”) for each service physically present on the TS and finally a CAT (“Conditional Access Table”) for access control.

Other tables specific to DVB in MPEG2 TS mode allow the decoder to navigate through the services. Some are compulsory:
NIT (“Network Information Table”), indicating the set of transponders and services rendered accessible to the subscriber by an operator;
SDT (“Service Description Table”) advising on the services present on a multiplex;
EIT (“Event Information Table”) giving information on the events in progress or the following (name of the transmission, name of the guests, start time, duration, etc.) on the services of the multiplex;
TDT (“Time and Date Table”) giving the universal date and time,
   and others optional. Finally there are private tables transported inter alia for interactive applications.

DVB is used to distribute digital television over telecommunication networks, in particular of ADSL (“Asymmetric Digital Subscriber Line”) type. In this application, one TS stream per channel is generally provided (SPTS stream, “Single Program Transport Stream”), encryption being carried out at the TS level. To view the content, the user's decoder has to receive a TS stream.

Video-on-demand services (VOD) also use the DVB standard. In this application, the telecommunication network supports the Internet Protocol (IP), and the TS streams are broadcast in point-to-point mode. Once the transmission of the requested program has begun, the user can deploy functionalities for play, pause and fast-forward or fast-rewind. These functionalities correspond to displacements with respect to the current position in the transport stream.

The interactivity of VOD services currently remains very limited. In particular, it is not possible to display the buttons of the menus provided on a DVD while associating corresponding actions with them. The PESs specific to the DVD standard which contain the interactivity elements are not managed by the decoder which is generally compatible only with DVB.

Today, certain VOD offerings comprise, after the transmission of the requested program, the dispatching of a DVD disk to the user's premises. The user will then be able to benefit from the interactivity of the DVD, but not when he first views the program. Furthermore, such an offering has the drawback of requiring that the content be dispatched to the user twice, in two different forms.

In order for a client of a VOD service to view a sub-titled video content, it is currently necessary for the sub-titles to be inlaid into the video part of the SPTS stream. This considerably increases the storage and/or processing capabilities required at the level of the VOD server. Furthermore, this causes the interactivity of the sub-titling available on a DVD to be lost.

The invention proposes a method of providing an on-demand multimedia service on the basis of multimedia data sources each comprising at least one program stream. According to the invention, the method comprises the following steps:
converting a program stream of at least one source into a transport stream;
extracting from the program stream packets describing elements overlayable on a video component of the transport stream;
transmitting the transport stream to a user terminal along a first channel by way of a telecommunication network;
in response to the receipt of a request originating from the user terminal by way of the telecommunication network, converting at least one of the packets describing overlayable elements into at least one data page and returning the data page to the user terminal along a second channel by way of the telecommunication network, said second channel being different from the first channel; and
on receipt of the data page at the user terminal, recovering the overlayable elements and displaying them in overlay with the video component of the transport stream.

In one embodiment, the overlayable elements comprise interactive menu buttons described in interactivity data packets extracted from the program stream. The data page then preferably contains a representation of the interactive menu buttons as well as an indication of actions respectively associated with these buttons and obtained in the interactivity data packets extracted from the program stream. In response to the selection of an interactive button at the user terminal, a new request will thus be able to be dispatched to the VOD platform to trigger the action associated with the button in question.

In this embodiment, the method makes it possible to emulate multimedia interaction functions of a first type on a transmission architecture of a second type, not designed to support such functions. The multimedia interaction functions of the first type can in particular be those offered by a DVD, while the architecture of the second type can be that of DVB. These two, mutually incompatible, systems nevertheless share the PES level of the MPEG2 standard, thereby allowing the conversion of the program stream into a transport stream with the aid of conventional MPEG2 demultiplexers and multiplexers.

The first channel is typically a DVB channel, while the second channel (different from the first channel) is a data channel of HTTP or analogous type. Generally, the transport stream and the packets of overlayable elements are transmitted, respectively, in a first channel and a second channel because they are decorrelated since they are put into distinct transport formats (transport streams and data pages respectively) even if they are transported by the same network (for example a network of ADSL type).

In another embodiment, the overlayable elements comprise sub-titles. Preferably, the data page then contains at least one sub-title associated with a respective display temporal index. It can also contain a script for controlling the automatic dispatching of a new request following the decoding of the last sub-title represented in the page. The sub-titles are thus transmitted in data pages without needing to be inlaid into the video stream before dispatch.

The method advantageously makes it possible to remotely utilize the interactive content of a film (multi-angle, sub-titles, chaptering, etc.), the interactive content of a DVD (bonus, games, making of, advertizing slot, etc.), all the types of games existing on DVD, all the fun-learning types of content existing on DVD and generally all the types of content exploiting the interactivity offered by the DVD system.

Another aspect of the invention pertains to a service platform for providing an on-demand multimedia service on the basis of multimedia data sources each comprising at least one program stream. This platform comprises: means for converting a program stream of at least one source into a transport stream; means for extracting, from the program stream, packets describing elements overlayable on a video component of the transport stream; means for transmitting the transport stream to a user terminal along a first channel by way of a telecommunication network; means for receiving requests originating from the user terminal by way of the telecommunication network; means for converting at least one of the packets describing overlayable elements into at least one data page in response to the receipt of a request originating from the user terminal; and means for returning the data page to the user terminal along a second channel by way of the telecommunication network.

Yet another aspect of the invention pertains to a computer program for installation in a service platform for providing an on-demand multimedia service on the basis of multimedia data sources each comprising at least one program stream. The program comprises instructions for controlling the following steps during execution of the program by a processing unit of the platform:
transmitting to a user terminal, along a first channel by way of a telecommunication network, a transport stream obtained by converting a program stream of at least one source;
extracting from the program stream packets describing elements overlayable on a video component of the transport stream;
in response to the receipt of a request originating from the user terminal by way of the telecommunication network, converting at least one of the packets describing overlayable elements into at least one data page and returning the data page to the user terminal along a second channel by way of the telecommunication network.

The invention also relates to a digital television decoder suitable for implementing the above method, and comprising:
an interface for communication with an on-demand multimedia service provision platform by way of a telecommunication network;
means for receiving along a first channel a transport stream representing a program requested by a user, decoding the transport stream and restoring the requested program; and
means for receiving along a second channel data pages comprising representations of interactive menu buttons and/or sub-titles and for displaying said buttons and/or sub-titles in overlay with a video component of the transport stream.

Other features and advantages of the present invention will be apparent in the description hereinafter of nonlimiting exemplary embodiments, with reference to the appended drawings, in which:

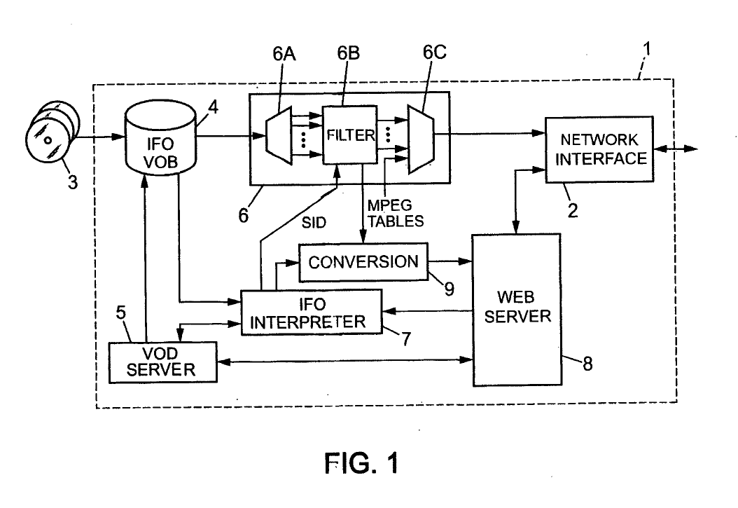

FIG. 1 is a schematic diagram of an exemplary VOD service platform according to the invention;

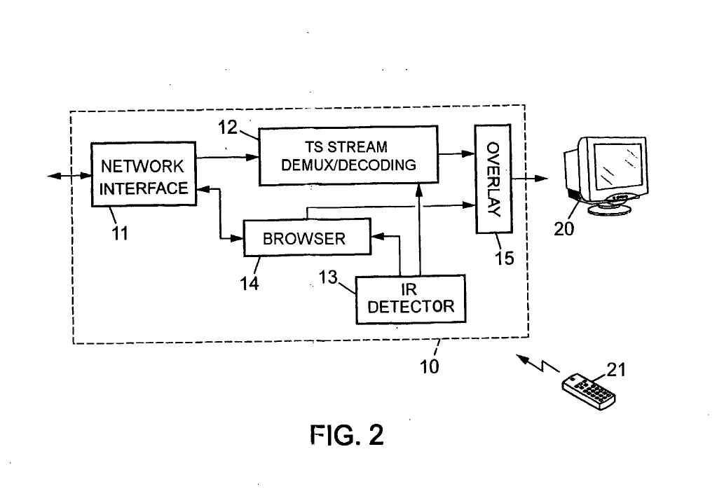

FIG. 2 is a simplified schematic diagram of an exemplary digital television decoder according to the invention; and

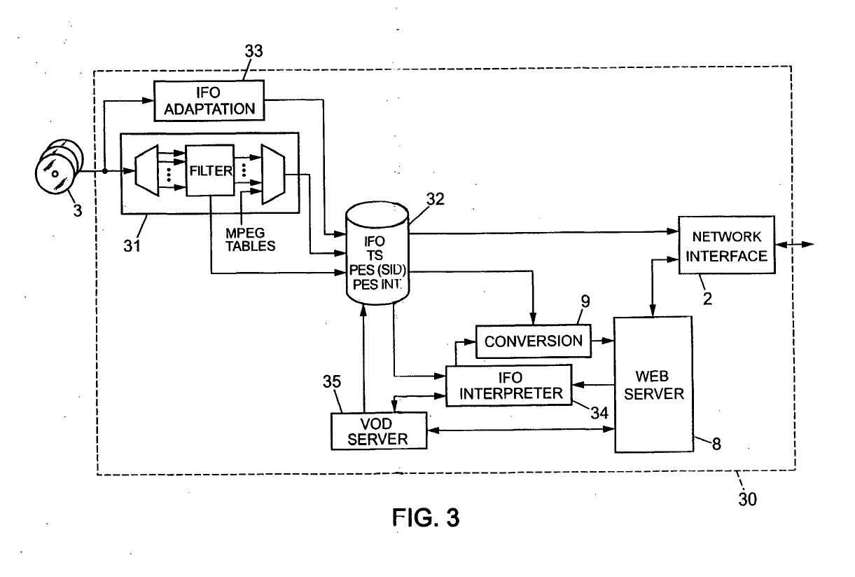

FIG. 3 is a schematic diagram of another exemplary VOD service platform according to the invention.

With reference to FIG. 1, a service platform 1 comprises a network interface 2 for communicating with user terminals. The telecommunications network employed is for example an IP over ADSL network.

The service platform according to the invention utilizes interactive contents available on recording media 3 of DVD or analogous type. In the realization illustrated by FIG. 1, a preliminary step of the method consists in recording the contents of the DVD 3 in a database 4 of the platform, stored on hard disks. For each DVD disk, the database 4 stores the entirety of the VOB files, which contain PS stream packets, as well as the corresponding interactivity information files (IFO) and their backups (BUP).

The platform 1 furthermore comprises a video-on-demand (VOD) server 5. In a conventional manner, the server 5 is adapted for presenting to the users, through a web server 8, a graphical interface which enables them to select the requested contents and to carry out the corresponding transactions. The server 5 manages the VOD sessions of the various users and steers the reading of the audio and video files corresponding to the contents requested by the users, as well as the optional sub-title files. In the present case, these files are recorded in the database 4 in the PS format, and the VOD server 5 must therefore be adapted for performing the addressing of the stream in the PS format.

The web server 8 dialogs with the users through the network interface 2, typically in the form of HTML (“HyperText Mark-up Language”) pages. It will be noted that other standards can be employed for the exchanges between the platform 1 and the terminals of the users, for example with the aid of flash formats.

The PS stream whose reading is controlled by the server 5 is submitted to an MPEG2 remultiplexer 6 which converts it into a single-program TS stream (SPTS) suitable for DVB transmission. The MPEG2 remultiplexing operation is conventional. The PES packets are extracted from the PS stream with the corresponding time markers, then the latter are utilized to multiplex the PES packets as a TS stream. The remultiplexer 6 is thus composed:
of a PS stream demultiplexer 6A which separates the various PES streams;
of a filter 6B which extracts the PES packets containing the interactivity data as well as certain optional PES packets containing sub-titles;
of a TS stream multiplexer 6C which assembles the TS stream from the audio and video PES streams read, inserting thereinto the MPEG tables necessary for transmission in DVB.

The TS stream thus constructed is transmitted to the user concerned by way of the interface 2 and of the telecommunications network.

The PES packets extracted by the filter 6B are submitted to a converter 9 whose role is to convert these packets into HTML pages (flash or other, etc.) which will optionally be transmitted via the server 8 so as to be displayed at the user's premises.

FIG. 2 shows schematically the DVB decoder 10 with which a user is equipped. Its network interface 11 recovers the TS stream received, and provides it to the MPEG2 demultiplexing and decoding module 12. This module 12 restores the audio and video signals which are provided to the user's television 20. Within the framework of the present invention, the demultiplexing and decoding module 12 can be standard.

The user interface typically comprises an infrared remote control 21 which, according to the user's actions, dispatches various signals sensed by an infrared detector 13 of the decoder 10.

The decoder 10 comprises a software communication layer 14, generally based on an application of HTML browser type for communicating with the web server 8 of the service platform 1 (an interpreter of flash or other type can also be used as a variant). The browser 14 is informed of certain user command signals sensed by the detector 13. Such signals pertain for example to pause/play or fast-forward/-rewind commands, that the browser 14 translates into HTML requests transmitted via the interface 11 and the telecommunications network according to the HTTP protocol (“HyperText Transfer Protocol”). These requests transport commands interpreted at the level of the VOD server 5 so as to give rise to corresponding modifications of the reading of the multimedia stream in the database 4.

Advantageously, the user commands that the browser 14 of the decoder 10 transmutes into HTML requests transmitted over the network also comprise interaction commands which are related to the interactivity information encountered in DVDs. Thus, commands such as changes of chapter or commands selectable from DVD menus displayed on the screen give rise to the transmission of specific HTML requests which will be interpreted by a module 7 added to the VOD server in the service platform 1. The user thus has the possibility of navigating around the tree of menus of the DVD that he is currently viewing.

The interpreter module 7 analyzes the interaction commands received in the HTML requests in relation with the IFO file, stored in the database 4, which corresponds to the video sequence whose transmission is in progress. The IFO interpreter 7 is similar to the one that is customarily encountered in DVD readers. For each DVD session in progress for a user, it allocates in particular a memory area for emulating the five 16-bit registers storing the information which make it possible to act on the tree followed in the IFO file as a function of the earlier choices.

Thus, each command from the user can be interpreted so as to steer the addressing of the stream whose reading is in progress according to the chaptering of the DVD, to select audio files or sub-titles corresponding to languages chosen by the user, to select video portions corresponding to camera angles chosen by the user, to select PESs associated with the displaying of a menu, etc.

As a function of the result of the interpretation of the commands, the VOD server 5 controls the reading in memory of the PS stream that is to be provided to the remultiplexer 6.

HTTP is a protocol based on a request-response scheme. A client who dispatches a request to a server waits for a response which indicates to him whether his request has been taken into account, processed successfully, undergoing processing, etc. In one realization of the invention, the VOD platform 1 does not immediately return a response to the request dispatched by the browser 14 of the decoder, or otherwise a provisional response indicating thereto that the processing of the request by the server is in progress. The request forms the subject of a timeout so as to leave the platform time to perform the required processing.

The interpreter 7 then determines the position on which the VOD server 5 must position itself. A command is dispatched to the VOD server giving for the subscriber, the broadcast program the position from which broadcasting is resumed. Starting from this new position, the stream in the PS format (DVD) is dispatched to the demultiplexer 6. The latter generates on the one hand a stream in the TS format (DVB) appropriate for audiovisual program broadcasting over IP. In parallel, the interactivity data extracted by the filter 6B are recovered by the converter 9, as are any optional sub-title files.

If the command entered by the user must give rise to the displaying of a menu, the interpreter 7 controls the converter 9 so that it generates an HTML page, including the description of the buttons and actions associated with them. This page is provided to the web server 8 which then generates the response to the request of the decoder with the web page in the body of the response. This message is dispatched in the data channel and not in the DVB stream. The browser 14 of the decoder 10 interprets the page returned and displays its content, including the associated images, overlaid with the video stream received on the DVB channel (overlay module 15 of FIG. 2). The user's following actions with the aid of his remote control 21 will then be analyzed by the browser 14 in relation with the actions associated with the buttons for triggering, if necessary, new HTTP requests to the platform.

An analogous method is employed to display the sub-titles optionally selected by the user.

Initially, a sub-titles selection menu is displayed in the manner described above. In response to the selection of one of the sub-titling languages by the user, the browser 14 dispatches to the platform 1 an HTTP request that the interpreter 7 analyzes in order to recover the selected language. The sub-title identifier (SID) corresponding to this language is included in a command dispatched to the filter 6B of the remultiplexer 6 so that the latter extracts the PS stream read under the control of the VOD server 5, the PES packets corresponding to the sub-titles to be displayed. These packets are provided to the converter 9 so that it constructs HTML pages on the fly. Each page thus generated contains a certain number of sub-images of sub-titles to be displayed during the video sequence, these sub-images having been decoded by the converter 9. The sub-titles contained in one and the same page are each associated with a respective temporal index included in the page (in the HTML standard, such an index makes it possible to display only a part of a page at the instant pointed at). This index corresponds to the waiting lag indicated in the SP_DCSQ so that the sub-title is displayed at the desired instant.

On receipt of such a page, the HTML browser 14 of the decoder 10 recovers the sub-images and displays them in overlay (overlay module 15) at the instants indicated in the page.

When it reaches the last sequence included in an HTML page, the converter 9 inserts a script into the page (javascript for example). This script is interpreted locally by the browser 14 so as to generate a new HTTP request to the web server 8, asking for the next page with the following sub-titles to be displayed. This affords simple management at the level of the server applying the filtering of the PESs, avoiding the need to preserve a context for each of the subscribers using the sub-titling functionality.

FIG. 3 illustrates another possible architecture of the VOD service platform according to the invention. In this platform 30, the remultiplexing of the PS stream, read on a DVD 3, into a TS stream is performed not in real time during a VOD session, but in the preliminary phase of recording the content of the disk 3. There is therefore not such a strong speed constraint on the MPEG2 remultiplexer 31.

The multimedia streams are therefore recorded in the TS format in the database 32 of the platform 30. The addressing of the stream used in the IFO files of the DVD must be modified so as to take account of the rearrangement of the stream. This modification is performed by an adaptation module 33 in parallel with the remultiplexing operation. The adapted IFO files are recorded in the database 32 in relation with the corresponding sequences of the TS stream.

The IFO interpreter 34 of the platform 30 then utilizes the adapted IFO files in order to address to the VOD server 35 the addressing parameters for the stored TS stream. In this embodiment, the VOD server 35 can be of conventional type for steering TS stream memory reading.

The filter of the remultiplexer 31 extracts from the PS stream the PES packets containing the interactivity data as well as those containing sub-titles so that they are recorded in the database 32 in relation with the corresponding sequences of the TS stream. Each sub-title PES is recorded in association with its SID identifier. For the dispatching of HTML pages containing one or more sub-titles, the IFO interpreter 34 controls the reading of the PES files associated with the SID recovered in the HTTP request arising from the decoder so that they are provided to the converter 9. The same manner of operation applies for the construction of the menu button pages.

The advantages of the embodiment of FIG. 3 are that it makes it possible to use a commercial VOD server and to avoid the real-time remultiplexing operation, which is relatively expensive in terms of calculation capacity.

In practice, in one or the other of the embodiments described, the invention may be implemented by means of computer programs executed by one or more processors of the service platform 1, 30 and designed to supplement the functionalities of the VOD server 5, 35.

The invention has been described above within the framework of the DVD and DVB standards. Naturally, it is not limited to these standards. The invention is in particular applicable to all types of media for recording interactive contents (HD-DVD, Blu Ray, etc.).

Moreover, the user equipment can have very diverse forms. For example, the decoder 10 can form part of a microcomputer whose screen and sound card serve for restoring the multimedia content and whose user interface (keyboard, mouse, etc.) serves for inputting the interaction commands.

1. A method of providing an on-demand multimedia service on the basis of multimedia data sources each comprising at least one program stream, wherein the method comprises the steps of:
converting a program stream of at least one source into a transport stream;
extracting from the program stream packets describing elements overlayable on a video component of the transport stream;
transmitting the transport stream to a user terminal along a first channel by way of a telecommunication network;
in response to the receipt of a request originating from the user terminal by way of the telecommunication network, converting at least one of the packets describing overlayable elements into at least one data page and returning the data page to the user terminal along a second channel by way of the telecommunication network, said second channel being different from the first channel; and
on receipt of the data page at the user terminal, recovering the overlayable elements and displaying them in overlay with the video component of the transport stream.

2. The method as claimed in claim 1, wherein the overlayable elements comprise interactive menu buttons described in interactivity data packets extracted from the program stream.

3. The method as claimed in claim 2, wherein the data page contains a representation of the interactive menu buttons as well as an indication of actions respectively associated with said buttons and obtained in the interactivity data packets extracted from the program stream.

4. The method as claimed in claim 3, furthermore comprising, in response to the selection of an interactive button at the user terminal, the dispatching of a new request to trigger the action associated with said button.

5. The method as claimed in claim 1, in which the overlayable elements comprise sub-titles.

6. (canceled)

7. The method as claimed in claim 6, furthermore comprising the insertion of a script into the data page for controlling the automatic dispatching of a new request following the decoding of the last sub-title represented in said page.

8. The method as claimed in claim 1, wherein the conversion of the program stream into a transport stream comprises a prior storage of multimedia files obtained on the basis of the multimedia data source and, in response to an interaction control originating from the user terminal, a multiplexing of said multimedia files to form the transport stream transmitted by way of the telecommunication network.

9. The method as claimed in claim 1, wherein after conversion of the program stream, the transport stream is stored in relation with the packets describing the overlayable elements so as to be read in a synchronized manner.

10. (canceled)

11. (canceled)

12. A service platform for providing an on-demand multimedia service on the basis of multimedia data sources each comprising at least one program stream, the platform comprising:
means for converting a program stream of at least one source into a transport stream;
means for extracting, from the program stream, packets describing elements overlayable on a video component of the transport stream;
means for transmitting the transport stream to a user terminal along a first channel by way of a telecommunication network;
means for receiving requests originating from the user terminal by way of the telecommunication network;
means for converting at least one of the packets describing overlayable elements into at least one data page in response to the receipt of a request originating from the user terminal; and
means for returning the data page to the user terminal along a second channel by way of the telecommunication network.

13. The service platform as claimed in claim 12, wherein the overlayable elements comprise interactive menu buttons described in interactivity data packets extracted from the program stream.

14. The service platform as claimed in claim 13, wherein the data page contains a representation of the interactive menu buttons as well as an indication of actions respectively associated with said buttons and obtained in the interactivity data packets extracted from the program stream.

15. The service platform as claimed in claim 12, wherein the overlayable elements comprise sub-titles, the data page containing at least one sub-title associated with a display temporal index.

16. The service platform as claimed in claim 15, wherein the means (9) for converting the packets describing overlayable elements are designed to insert into the data page a script for controlling the automatic dispatching of a new request following the decoding of the last sub-title represented in said page.

17. A computer program for installation in a service platform for providing an on-demand multimedia service on the basis of multimedia data sources each comprising at least one program stream, the program comprising instructions for controlling the following steps during execution of the program by a processing unit of the platform:
transmitting to a user terminal, along a first channel by way of a telecommunication network, a transport stream obtained by converting a program stream of at least one source;
extracting from the program stream packets describing elements overlayable on a video component of the transport stream; and
in response to the receipt of a request originating from the user terminal by way of the telecommunication network, converting at least one of the packets describing overlayable elements into at least one data page and returning the data page to the user terminal along a second channel by way of the telecommunication network.

18. A digital television decoder suitable for implementing a method as claimed in claim 1, comprising:
an interface for communication with an on-demand multimedia service provision platform by way of a telecommunication network;
means for receiving along a first channel a transport stream representing a program requested by a user, decoding the transport stream and restoring the requested program; and
means for receiving along a second channel data pages comprising representations of interactive menu buttons and/or sub-titles and for displaying said buttons and/or sub-titles in overlay with a video component of the transport stream.
